(19) United States
(12) Patent Application Publication
(10) Pub. No.: US 2017/0011628 A1
(43) Pub. Date: Jan. 12, 2017

(54) TRAFFIC LIGHT REPLICATOR IN A BUS OR TRUCK

(71) Applicant: Continental Automotive Systems, Inc., Auburn Hills, MI (US)

(72) Inventor: Antonio Rios Cortes, Tlajomulco de Zuniga (MX)

(21) Appl. No.: 14/796,545

(22) Filed: Jul. 10, 2015

(51) Int. Cl. G08G 1/0955; B60Q 1/30

(52) U.S. Cl. CPC G08G 1/0955; B60Q 1/302

(57) ABSTRACT

A traffic light replicator which includes a display unit on the back of a large vehicle, such as a bus or truck, which displays the mode of operation of an upcoming stoplight such that a vehicle located behind the large vehicle may be made aware of the mode of operation of the stoplight when the stoplight has been obstructed from the view of the smaller vehicle. The traffic light replicator includes a control unit, a camera, and a display unit having multiple display lights. The control unit receives a signal from the camera indicating the mode of operation of the stoplight, and the control unit then commands the display unit to activate one of the display lights to correspond to the mode of operation of the stoplight, so as to alert the driver of a vehicle located behind the large vehicle of the current mode of operation of the stoplight.

### FIELD OF THE INVENTION

The invention relates generally to a display unit on the back of a large vehicle, such as a bus or truck, which displays the mode of operation of an upcoming stoplight such that a smaller vehicle located behind the large vehicle may be made aware of the mode of operation of the stoplight when the stoplight has been obstructed from the view of the driver of the smaller vehicle.

### BACKGROUND OF THE INVENTION

There are many different types of large vehicles in use today for various purposes. These large vehicles consist of busses, semi-trucks, construction vehicles, and the like. These large vehicles use the same roads that are also travelled by mid-size and smaller vehicles. Due to this disparity in size, there are times when the driver of one of these mid-size or smaller vehicles may have their view obstructed by a large vehicle. This may particularly occur at an intersection when the mid-size or smaller vehicle is positioned behind a larger vehicle when approaching or fully stopped at a stoplight. In this situation, the view of the stoplight may be obstructed by the large vehicle, such that the driver of the mid-size or small vehicle may not be able to determine which mode of operation the stoplight is in.

Typical stoplights have three lights (a green light, a yellow light, and a red light) which are illuminated at different times, depending upon the mode of operation of the stoplight. More specifically, there is typically a green light which is illuminated in a first mode of operation to alert oncoming drivers that they may proceed through the intersection, a yellow light which is illuminated in a second mode of operation to alert oncoming drivers that the stoplight is transitioning from the green light to the red light, and a red light which is illuminated in a third mode of operation to alert oncoming drivers that they must stop at the intersection.

Obstructing the view of the drivers of the smaller vehicles may cause several problems, which may occur if the large vehicle stops suddenly due to a change in the mode of operation of the stoplight, and the driver of the smaller vehicle is unaware the red light of the stoplight is illuminated, alerting oncoming vehicles to stop. Another concern may occur if the yellow light of the stoplight is illuminated, and there is enough time for the large vehicle to pass through the intersection, and not enough time for the smaller vehicle. The driver of the smaller vehicle may be unaware there is not enough time to pass through the intersection, risking a collision at the intersection if the light changes modes of operation, and other traffic proceeds through the intersection.

Accordingly, there exists a need for a device which facilitates the awareness of the mode of operation of a stoplight when the driver of a mid-sized or small vehicle is driving behind a larger vehicle when approaching a stoplight at an intersection.

### SUMMARY OF THE INVENTION

The present invention is a traffic light replicator which includes a display unit on the back of a large vehicle, such as a bus or truck, which displays the mode of operation of an upcoming stoplight such that a smaller vehicle located behind the large vehicle may be made aware of the mode of operation of the stoplight when the stoplight has been obstructed from the view of the smaller vehicle by the larger vehicle.

The traffic light replicator functions to replicate the mode of operation of an upcoming stoplight, so as to alert the driver of a small or mid-size vehicle (located behind a larger vehicle) of the current mode of operation of the stoplight.

In one embodiment, the present invention is a traffic light replicator for a vehicle which includes a control unit, and a camera mounted to a vehicle, where the camera operable for detecting the mode of operation of a stoplight. The traffic light replicator also includes a display unit controlled by the control unit, where the display unit is mounted to the rear panel of the vehicle. The display unit has a first display light, a second display light, and a third display light. The control unit receives a signal from the camera indicating the mode of operation of the stoplight, and the control unit then commands the display unit to activate the first display light when the stoplight is in the first mode of operation, the second display light when the stoplight is in the second mode of operation, and the third display light when the stoplight is in the third mode of operation.

In one embodiment, the camera may be mounted above the windshield of the vehicle. However, it is within the scope of the invention that the camera may be mounted to other parts of the vehicle, such as the grille, the hood, the roof, or any other part such that the camera may be able to detect the mode of operation of an upcoming stoplight.

In alternate embodiments, the camera may be used to detect the mode of operation of other types of traffic lights as well, such as traffic lights that have more or less lights and signals, as well as left-hand turn or right-hand turn stoplights. Furthermore, the traffic light replicator of the present invention may also be configurable for use in different countries, which may have various types of traffic signals.

In yet other alternate embodiments, the camera may be replaced with another type of sensor, or other device that may be suitable for communication with the stoplight such that a signal may be sent to the control unit indicating the mode of operation of the stoplight.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a large vehicle having a traffic light replicator, according to embodiments of the present invention;

FIG. 2A is a rear view of large vehicle having a traffic light replicator in a first mode of operation, according to embodiments of the present invention;

FIG. 2B is a rear view of large vehicle having a traffic light replicator in a second mode of operation, according to embodiments of the present invention; and

FIG. 2C a rear view of large vehicle having a traffic light replicator in a third mode of operation, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

A vehicle having a traffic light replicator system according to the present invention is shown in the Figures generally at 10. The traffic replicator system, shown generally at 12, includes a sensing device, which in this embodiment is a camera 14. The traffic light replicator 12 also includes a control unit 16 and a display unit 18. The camera 14 in this embodiment is front-facing, and mounted above the windshield 20. The camera 14 detects an upcoming stoplight, shown generally at 22, and more specifically, the camera 14 detects which indicator light of the stoplight 22 is activated. In the embodiment shown, the stoplight 22 has three indicator lights, a top light 22a, which is red, a middle light 22b, which is yellow, and a bottom light 22c, which is green. The top light 22a alerts oncoming vehicles to stop at an intersection, the middle light 22b provides an indication that the stoplight 22 is transitioning from the bottom light 22c to the top light 22a, and the bottom light 22c alerts oncoming vehicles to proceed.

The display unit 18 also includes three display lights 18a,18b,18c, the activation of which corresponds to the activation of the indicator lights 22a,22b,22c of the camera 14. More specifically, in this embodiment, the first display light 18a corresponds to the activation of the first indicator light 22a of the stoplight 22, the second display light 18b corresponds to the activation of the second indicator light 22b of the stoplight 22, and the third display light 22c corresponds to the activation of the third indicator light 22c of the stoplight 22.

The control unit 16 is in communication with and controls both the display unit 18 and the camera 14. The control unit 16 receives different signals from the camera 14 based on which of the indicator lights 22a,22b,22c is activated, and commands the display unit 18 to activate the display light 18a,18b,18c which corresponds to the activated indicator light 22a,22b,22c.

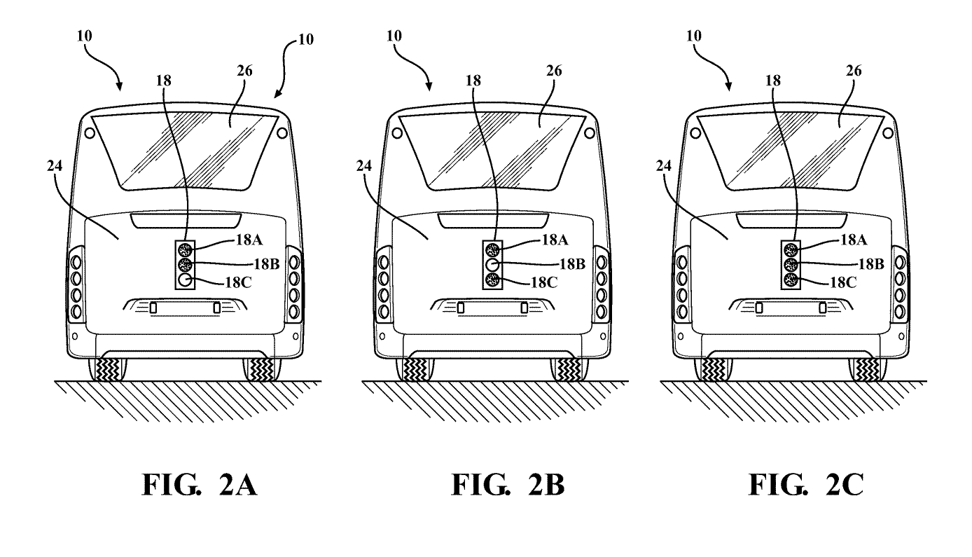

The display unit 18 is mounted on a rear panel 24 of the vehicle 10, below the rear windshield 26, in a location such that the display unit 18 may be easily seen by drivers in other vehicles behind the vehicle 10. Although the display unit 18 is mounted as shown in FIGS. 2A-2C, it is within the scope of the invention that the display unit 18 may be mounted in other locations such that drivers of surrounding vehicle may easily see the display unit 18.

In operation, when the vehicle 10 is approaching the stoplight 22, and the stoplight 22 has one of the indicator lights 22a,22b,22c activated, the camera 14 detects which of the indicator lights 22a,22b,22c is activated, and a signal is sent to the control unit 16 by the camera 14 indicating which of the indicator lights 22a,22b,22c is activated. The control unit 16 then sends a signal to the display unit 18, and the corresponding display light 18a,18b,18c is activated. More specifically, if the first indicator light 22a is illuminated, the camera 14 detects the illumination of the first indicator light 22a, and a signal that the first indicator light 22a is illuminated is sent to the control unit 16. The control unit 16 then commands the display unit 18 to activate the first display light 18a.

If the second indicator light 22b is illuminated, the camera 14 detects the illumination of the second indicator light 22b, and a signal that the second indicator light 22b is illuminated is sent to the control unit 16. The control unit 16 then commands the display unit 18 to activate the second display light 18b.

If the third indicator light 22c is illuminated, the camera 14 detects the illumination of the third indicator light 22c, and a signal that the third indicator light 22c is illuminated is sent to the control unit 16. The control unit 16 then commands the display unit 18 to activate the third display light 18c.

Any vehicle that is located behind the vehicle 10 is able to see which of the display lights 18a,18b,18c is illuminated, alerting the driver of the vehicle behind the vehicle 10 which of the indicator lights 22a,22b,22c is illuminated, so the driver than may plan on stopping or proceeding, depending upon which of the lights 22a,22b,22c is illuminated. One of the benefits of the present invention is the use of the display unit 18 provides an indication of which of the lights 22a,22b,22c is illuminated when the driver of a vehicle behind the vehicle 10 cannot see the stoplight 22. This is especially beneficial when smaller vehicles are behind the vehicle 10.

The traffic light replicator 12 is also able to detect when one of the lights 22a,22b,22c is blinking as well. For example, if the first light 22a is blinking, the camera 14 detects that the first light 22a is blinking, and the control unit 16 then commands the display unit 18 to configure the first display light 18a to blink.

Another feature of the traffic light replicator 12 is that the camera 14 is also able to detect an upcoming stop sign. If an upcoming intersection has a stop sign, the camera 14 detects the stop sign, and a signal is sent to the control unit 16 that a stop sign has been detected. The control unit 16 then commands the display unit 18 to configure the first display light 18a to blink (or be illuminated without blinking), indicating that the vehicle 10 is going to be stopping at the upcoming intersection.

Although the camera 14 is shown as being located above the windshield 20, it is within the scope of the invention that the camera 14 may be mounted in other locations. For example, the camera 14 may be mounted in other locations, such as, but not limited to, above the grille 28, on either side of the windshield 20, on the hood 30, or on the roof 32 of the vehicle 10.

It is also within the scope of the invention that the camera 14 is suitable to detect the mode of operation of other types of traffic lights as well, such as traffic lights that have more or less lights and signals, as well as left-hand turn or right-hand turn stoplights.

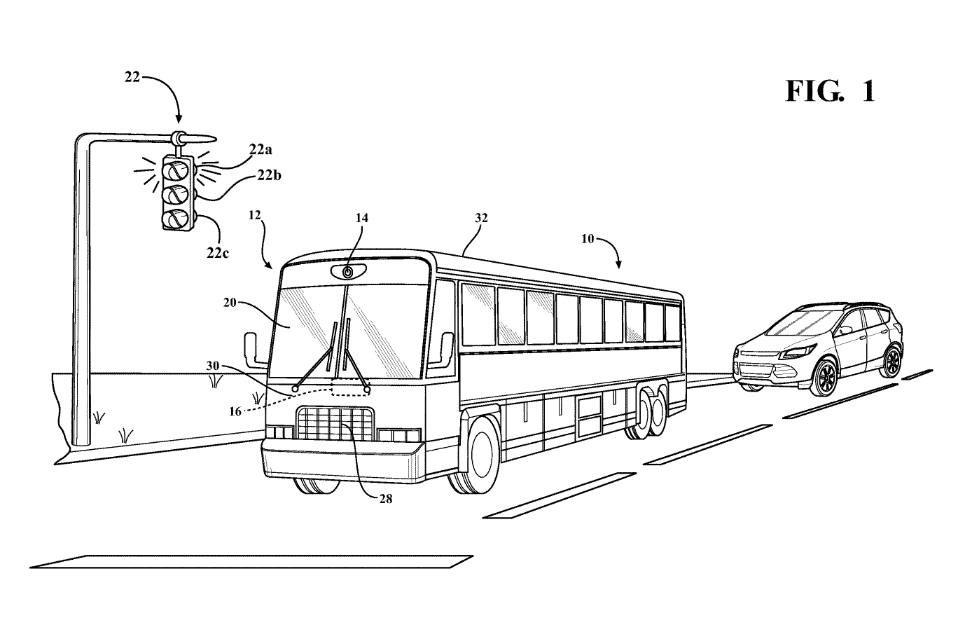

The traffic light replicator 12 of the present invention may also be configurable for use different countries, which have traffic signals that are different than the stoplight 22 shown in FIG. 1.

Furthermore, it is also within the scope of the invention that the camera 14 may be replaced with another type of sensor, or any other device that may be suitable for detecting the mode of operation of the stoplight 22 such that a signal may be sent to the control unit indicating the mode of operation of the stoplight 22. Additionally, the stoplight 22 may be configured to communicate with the device (if the camera 14 is not used) to provide an indication of the mode of operation of the stoplight 22.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
a traffic light replicator, including:
a sensing device;
a control unit for receiving a signal from the sensing device indicating the mode of operation of a stoplight; and
a display unit controlled by the control unit;
wherein the sensing device detects the mode of operation of the stoplight, and sends a signal to the control unit indicating the condition of the stoplight, the control unit then commands the display unit to display corresponding to the mode of operation of the stoplight.

2. The apparatus of claim 1, the display unit further comprising a plurality of display lights, wherein one or more of the plurality of display lights are illuminated to correspond to the mode of operation of the stoplight.

3. The apparatus of claim 2, the plurality of display lights further comprising:
a first display light operable for illuminating when the stoplight is in a first mode of operation;
a second display light operable for illuminating when the stoplight is in a second mode of operation; and
a third display light operable for illuminating when the stoplight is in a third mode of operation;
wherein one of the first display light, the second display light, and the third display light is activated based on the signal sent to the control unit by the sensing device.

4. The apparatus of claim 1, wherein the display unit is mounted to the rear panel of a vehicle.

5. The apparatus of claim 1, wherein the sensing device is mounted to one selected from the group consisting of a grille, a hood, and a roof.

6. The apparatus of claim 1, the sensing device further comprising a camera operable for detecting the mode of operation of the stoplight, and sending a signal to the control unit indicating the mode of operation of the stoplight.

7. A traffic light replicator for a vehicle, comprising:
a control unit;
a camera mounted to a vehicle, the camera being operable for detecting the mode of operation of a stoplight; and
a display unit mounted to the vehicle, the control unit controlling the camera and the display unit;
wherein the camera sends a signal to the control unit, the signal indicating the mode of operation of the stoplight, and the control unit sends a signal to the display unit, configuring the display unit to correspond to the mode of operation of the stoplight.

8. The traffic light replicator for a vehicle of claim 7, the display unit further comprising:
a first display light operable for illuminating when the stoplight is in a first mode of operation;
a second display light operable for illuminating when the stoplight is in a second mode of operation; and
a third display light operable for illuminating when the stoplight is in a third mode of operation;
wherein one of the first display light, the second display light, and the third display light is activated based on the signal sent to the control unit by the camera.

9. The traffic light replicator for a vehicle of claim 7, wherein the camera is mounted to one selected from the group consisting of a grille, a hood, and a roof.

10. The traffic light replicator for a vehicle of claim 7, wherein the display unit is mounted to the rear panel of the vehicle.

11. A traffic light replicator for a vehicle, comprising:
a control unit;
a camera mounted to a vehicle, the camera operable for detecting the mode of operation of a stoplight;
a display unit controlled by the control unit, the display unit being mounted to the rear panel of the vehicle;
a first display light being part of the display unit;
a second display light being part of the display unit; and
a third display light being part of the display unit;
wherein the control unit receives a signal from the camera indicating the mode of operation of the stoplight, and the control unit then commands the display unit to activate the first display light when the stoplight is in a first mode of operation, the second display light when the stoplight is in a second mode of operation, and the third display light when the stoplight is in a third mode of operation.

12. The traffic light replicator for a vehicle of claim 11, wherein the camera is mounted to one selected from the group consisting of a grille, a hood, and a roof.
